(19) United States
(12) Patent Application Publication
(10) Pub. No.: US 2026/0109408 A1
(43) Pub. Date: Apr. 23, 2026

(54) Rear floor panel and structural assembly for a motor vehicle

(71) Applicant: ArcelorMittal, Luxembourg (LU)

(72) Inventor: Joel WILSIUS, Paris (FR)

(21) Appl. No.: 19/113,201

(22) PCT Filed: Sep. 28, 2023
(86) PCT No.: PCT/IB2023/059684

§ 371 Date: Mar. 19, 2025

(30) Foreign Application Priority Data
Oct. 7, 2022 (WO) PCT/IB2022/059611

(51) Int. Cl. B62D 25/20; B62D 21/15; B62D 25/16; B62D 27/02; B62D 29/00

(52) U.S. Cl. CPC B62D 25/2036; B62D 21/15; B62D 25/16; B62D 27/023; B62D 29/007

(57) ABSTRACT

Rear floor panel for an automotive vehicle made from a single metallic blank and including reinforced rear and front side portions compared to the center rear and front portions. Rear structural assembly including a rear floor panel assembled onto a rear underfloor structure, including a right and left side member linked together by at least one cross member.

The present invention relates to a rear floor panel for a motor vehicle and to a rear structural assembly for a motor vehicle.

### BACKGROUND

Car makers are submitted to ever more demanding requirements. They are requested to increase the passive safety of vehicles and at the same time to reduce the vehicle weight in order to minimize greenhouse gas emissions for internal combustion engines or increase the vehicle's driving range for electric vehicles. Furthermore, vehicle production costs must stay low and productivity rates high and car makers are looking to simplify vehicle production by lowering the number of separate individual parts.

### SUMMARY OF THE INVENTION

The rear floor panel and the rear structural assembly are key structural elements which contribute to the safety of the occupants in case of a rear crash and a side impact. They further protect the gas tank, often located below the passenger seats, in case of a combustion engine. They can protect the rear electric engine in case of an electric or hybrid vehicle. They also help to protect the battery pack or the hydrogen tank, usually located below the vehicle, in the case of electric powered vehicles or fuel cell vehicles.

They are involved in ensuring the good safety performance of a vehicle, for example in the following standardized rear crash simulations:
The National Highway Traffic Safety Association (NHTSA) rear crash assessment in which the vehicle is impacted by a deformable barrier weighing 1368 kg, covering a 70% width offset and travelling at an initial velocity of 80 km/h.
The European New Car Assessment Program (Euro-NCAP) and the China New Car Assessment Program (C-NCAP) rear crash tests in which the vehicle is impacted by a rigid barrier weighing 1100 kg, covering a full 100% width offset and travelling at an initial velocity of 50 km/h.

They are involved in ensuring the good safety performance of a vehicle, for example in the following standardized side impact simulations:
the US New Car Assessment Program's (USNCAP) pole tests, in which a vehicle having an initial lateral speed of 32.2 km/h impacts on its side a fixed pole.
the IIHS's side moveable deformable barrier (MDB) test, in which a vehicle is impacted on its side by a deformable barrier having a weight of 1500 kg and travelling at a speed of 50 km/h.

These normalized tests are regularly updated to take into account even more severe crash conditions, for example by increasing the weight of the barrier, the speed of impact and the required criteria to pass the test.

Both the rear floor panel and the rear structural assembly consist of numerous individual parts. Manufacturing said parts involve costly manufacturing processes: multiple forming operations and assembly steps to obtain the finished structure.

It is an object of the present invention to address the combined challenges of safety, weight reduction and high productivity by providing a rear floor panel and a rear structural assembly having a reduced number of parts, an excellent safety performance and an optimized total weight.

The inventive design can be produced and assembled in very few manufacturing steps compared to the reference. On top of simplifying production, mitigating costs and increasing productivity, diminishing the number of production steps also diminishes the environmental footprint of the production process and diminishes overall CO2 emissions when manufacturing the vehicle.

The present invention provides a rear floor panel for a motor vehicle extending longitudinally from the rear extremity of said vehicle to the front extremity of the back passenger seats and extending transversally between a left and right wheelhouse and a left and right rocker inner, said rear floor panel comprising a front portion extending below the back passenger seats and a rear portion extending behind the back passenger seats, said front and rear portions each respectively comprising a left, center and right portion, wherein
said rear floor panel is made by forming a single metal sheet,
the right and left front portions are assembled to the right and left rocker inner panels and are located at a lower elevation than the rear portion,
each of said rear left and right portions comprise at least an area having a product of ultimate tensile strength UTS expressed in MPa, by average thickness, expressed in mm, which is at least twice as high as the product of UTS by average thickness of said rear center portion,
each of said front left and right portions comprise at least an area having a product of ultimate tensile strength UTS by average thickness which is at least twice as high as the product of UTS by average thickness of said front center portion.

The present invention also provides a rear structural assembly for an automotive vehicle comprising at least a rear floor as described above and a rear underfloor structure comprising itself a left and right side member and at least one cross member linking said right and left side members, wherein when said rear structural assembly is assembled in the vehicle:
the left rear and front portions of said rear floor panel form together with said rear underfloor structure left member a closed section encompassing a left hollow volume,
the right rear and front portions of said rear floor panel form together with said rear underfloor structure right member a closed section encompassing a right hollow volume,
the center rear and front portions of said rear floor panel form together with said rear underfloor structure's at least one cross member a closed section encompassing a center hollow volume.

### BRIEF DESCRIPTION OF THE DRAWINGS

Other aspects and advantages of the present invention will appear upon reading the following description, given by way of example, and made in reference to the appended drawings, wherein:

FIG. 1 is an overall perspective view of a vehicle comprising a rear floor panel according to the invention.

FIG. 2 is a perspective view of an embodiment of the rear floor panel according to the invention and its surrounding parts.

FIG. 3 is a perspective view of a first embodiment of the rear floor panel according to the invention.

FIG. 4 is a perspective view of a second embodiment of the rear floor panel according to the invention.

FIG. 5 is a perspective exploded view of an embodiment of the rear structural assembly according to the invention.

FIG. 6A is a perspective view of a rear structure assembly according to the invention as it would be when assembled on a vehicle and FIG. 6B is a cross section of FIG. 6A according to the cross-section plan A-A indicated on FIG. 6A.

### DETAILED DESCRIPTION

In the following descriptions and claims, the directional terms are defined according to the usual directions of a mounted vehicle.

In particular, the terms “top”, “up”, “upper”, “above”, “bottom”, “low”, “lower”, “below” etc. are defined according to the elevation direction of a vehicle. The terms “front”, “back”, “rear”, “front”, “forward”, backward” etc. are defined according to the longitudinal direction of a vehicle, i.e. the direction in which the vehicle moves when following a straight line. The terms “left”, “right”, “transverse”, etc. are defined according to the orientation parallel to the width of the vehicle. The terms “inner”, “outer” are to be understood according to the width direction of the vehicle: the “inner” is closest to the central axis of the vehicle, i.e. closest to the inside of the vehicle, whereas the “outer” is located further away from said central axis of the vehicle, in effect closer to the outside of the vehicle. The same applies to the terms “distal” and “central”: the “distal” part is located closest to the outside of the vehicle and the “central” part closest to the center of the vehicle. The term “horizontal” refers to the orientation of the plane comprising the longitudinal and the transverse directions. The term “vertical” refers to any orientation comprising the elevation direction.

In the following figures, the orientations and spatial references are all made using an X, Y, Z coordinates referential, wherein Z is the elevation direction of the vehicle, X is the longitudinal direction of the vehicle and Y is the transverse direction of the vehicle. The referential is represented in each figure. When the figure is a 2D flat representation, the axis which is outside of the figure is represented by a dot in a circle when it is pointing towards the reader and by a cross in a circle when it is pointing away from the reader, following established conventions.

By “substantially parallel” or “substantially perpendicular” it is meant a direction which can deviate from the parallel or perpendicular direction by no more than 15°.

A steel sheet refers to a flat sheet of steel. It has a top and bottom face, which are also referred to as a top and bottom side or as a top and bottom surface. The distance between said faces is designated as the thickness of the sheet. The thickness can be measured for example using a micrometer, the spindle and anvil of which are placed on the top and bottom faces. In a similar way, the thickness can also be measured on a formed part.

By average thickness of a part, or of a portion of a part, it means the overall average thickness of the material making up the part after it has been formed into a 3-dimensional part from an initially flat sheet.

Tailor welded blanks are made by assembling together, for example by laser welding, several sheets or cut-out blanks of steel, known as sub-blanks, in order to optimize the performance of the part in its different areas, to reduce overall part weight, to reduce overall part cost and to reduce material scrap. The sub-blanks forming the tailor welded blanks can be assembled with or without overlap, for example they can be laser butt-welded (no overlap), or they can be spot-welded to one another (with overlap).

By opposition to a tailor welded blank, a monolithic blank refers to a blank which consists of one single sub-blank, without several sub-blanks being combined together.

A tailor rolled blank is a blank having multiple sheet thicknesses obtained by differential rolling during the steel sheet production process.

The ultimate tensile strength, the yield strength and the elongation are measured according to ISO standard ISO 6892-1, published in October 2009. The tensile test specimens are cut-out from flat areas. If necessary, small size tensile test samples are taken to accommodate for the total available flat area on the part.

The bending angle is measured according to the VDA-238 bending standard. For the same material, the bending angle depends on the thickness. For the sake of simplicity, the bending angle values of the current invention refer to a thickness of 1.5 mm. If the thickness is different than 1.5 mm, the bending angle value needs to be normalized to 1.5 mm by the following calculation where α1.5 is the bending angle normalized at 1.5 mm, t is the thickness, and at is the bending angle for thickness t:

$$α1 \text{.5} = ( α t \times √ t ) / √ 1.5$$

Cold stamping is a forming technology for metals which involves shaping a metallic sheet into a formed part by pressing it between an upper and lower die, called the cold stamping tool. For example, the cold stamping tool has a blank holder to hold the metallic sheet on its sides. For example, the cold stamping tool consists of several steps, each involving an upper and lower die to produce complex shapes and/or to perform further operations such as punching holes in the part or trimming its sides. Other cold forming technologies exist such as for example roll forming, which involves bending a continuous sheet between a successive set of rolls, simple bending which involves bending a sheet of steel using a press and an upper and lower bending tool etc.

Hot stamping is a forming technology for steel which involves heating a blank of steel, or a preformed part made from a blank of steel, up to a temperature at which the microstructure of the steel has at least partially transformed to austenite, forming the blank or preformed part at high temperature by stamping it and simultaneously quenching the formed part to obtain a microstructure having a very high strength, possibly with an additional partitioning or tempering step in the heat treatment.

A multistep hot stamping process is a particular type of hot stamping process including at least one stamping step and consisting of at least two process steps performed at high temperature, above 300° C. For example, a multistep process can involve a first stamping operation and a subsequent hot trimming operation, so that the finished part, at the exit of the hot stamping process, does not need to be further trimmed. For example, a multistep process can involve several successive stamping steps in order to manufacture parts having more complex shapes than what can be realized using a single stamping operation. For example, the parts are automatically transferred from one operation to another in a multistep process, for example using a transfer press. For example, the parts stay in the same tool, which is a multipurpose tool that can perform the different operations, such as a first stamping and a subsequent in-tool trimming operation.

A partial hardening hot stamping process is a hot stamping process in which the heat profile to which the blank is submitted is purposely tailored to be different in different areas of the blank, in order to obtain different material properties in these different areas at the end of the hot stamping process. For example, this allows to produce hot stamped parts using a single metallic blank made of a single material which will have different levels of hardness and elongation in different areas of the final part. For example, this allows to produce parts having soft zones and hard zones, said soft zones being able to deform under an impact load in order to absorb energy, whereas said hard zones will resist intrusion by resisting deformation. There are several different technologies to implement partial hardening. For example, the material can be heated at different temperatures in different areas of the blank, the higher temperature areas will be fully austenitic at the exit of the austenitizing furnace resulting in a very hard microstructure after hot stamping, whereas the lower temperature areas will have an intercritical ferrite/austenite microstructure at the exit of the austenitizing furnace resulting in a lower hardness microstructure after hot stamping. For example, the material can be quenched at different quenching speeds in different areas of the blank during the hot stamping step itself, the areas quenched at a higher quenching speed will have a higher hardness than those quenched at a lower speed.

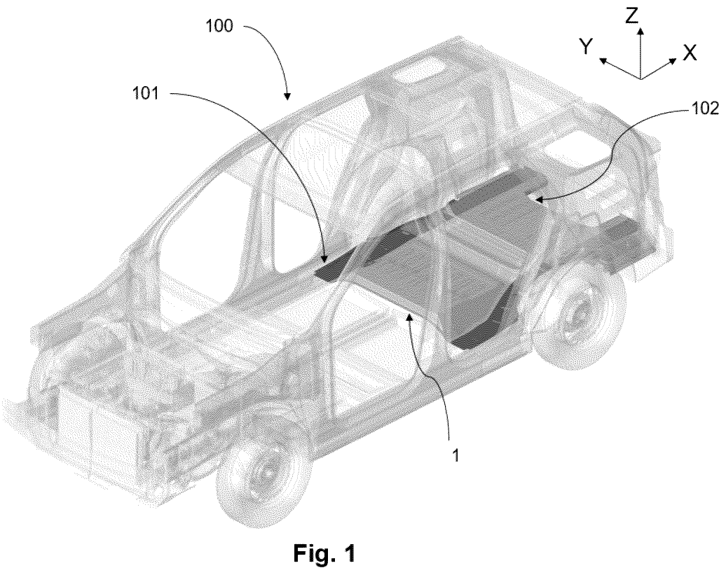

Referring to FIG. 1, a motor vehicle 100 has a passenger compartment 101 in which the occupants of the vehicle are located during the normal functioning of the vehicle. A rear floor panel 1 generally closes the bottom rear part of said passenger compartment and extends in a longitudinal direction all the way to the rear extremity of the vehicle. The rear floor panel 1 extends below the rear passenger seats and all the way into a rear trunk 102 of the vehicle, if said vehicle is equipped with a trunk.

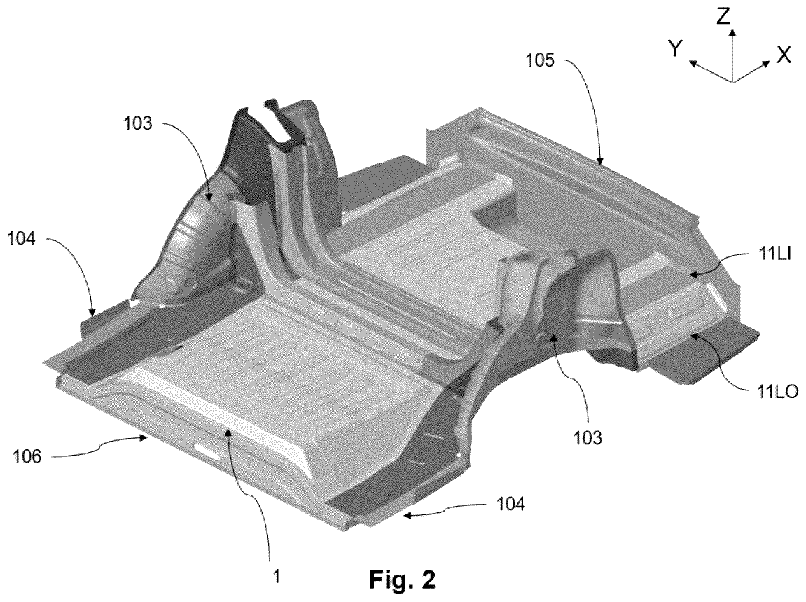

Referring to FIG. 2, said rear floor panel 1 is a large part extending longitudinally from the rear extremity of the vehicle to the front extremity of the back passenger seats and extending transversally between a left and right wheelhouse 103 and a left and right rocker inner 104. In FIG. 2, only a small portion of the rocker inner is represented, for clarity's sake. In fact, said rocker inner extends longitudinally over a large portion of the vehicle length.

Towards the rear end of the vehicle, the rear floor panel 1 is for example attached to a back panel 105, said back panel being itself attached to crash boxes and a rear bumper. At its front part, the rear floor panel is for example attached to a heal board 106, which is a transverse part located at the feet of the rear passengers, hence the terminology “heel board”.

All the above-described surrounding parts of the rear floor panel are given as examples of typical surrounding parts in a typical vehicle architecture but are in no way limitative of the current invention. Said surrounding parts are assembled to the rear floor panel, for example by resistance spot welding, or by remote laser welding or by mechanical assemblies such as clinching, riveting etc.

The rear suspension assembly of the vehicle is located below the rear portion of the rear floor panel. The presence of said suspension assembly and the fact that the passenger compartment 101 is generally designed to be as large as possible, in particular as high as possible in terms of elevation, entails that there is a difference in elevation within the rear floor panel 1. The left and right rocker inner 104 are located at a lower elevation than the rear part of the rear floor panel and since the sides of the rear floor panel are connected to the rocker inner, the side of the front part of the rear floor panel are located at a lower elevation than the rear portion of the rear floor panel.

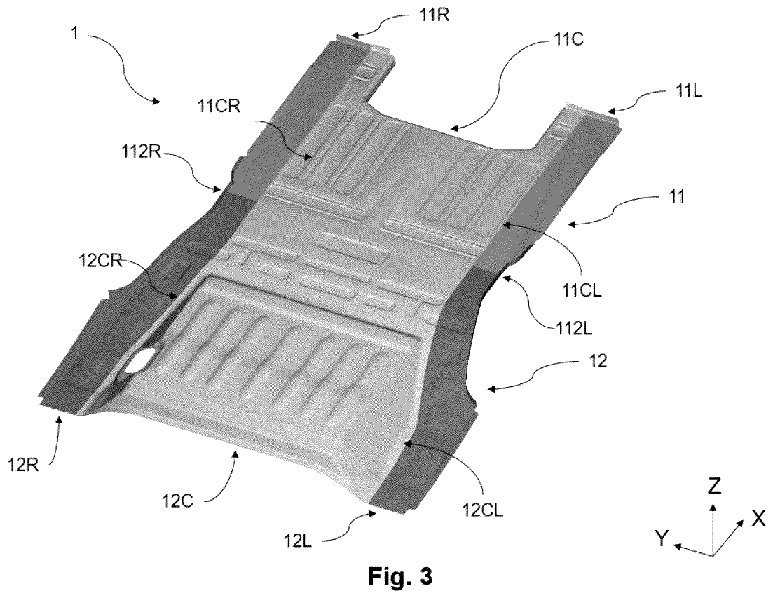

In order to better understand the conception of the rear floor panel 1 according to the present invention, it will be divided into six portions: the rear and front portions each having a left, center and right portion. Turning to FIG. 3, said portions have the following references:

The rear portion 11, which extends behind the back passenger seats and which is divided respectively into the left, center and right rear portions 11L, 11C and 11R—the left and right rear portions will also be referred to as the rear side portions.

The front portion 12 extends at the level of the back passenger seats in the longitudinal direction. The front portion 12 is located directly below the back passenger seats and is part of the passenger compartment 101. Said front portion 12 is divided respectively into the left, center and right front portions 12L, 12C and 12R, the left and right front portions will also be referred to as the front side portions.

The right and left front portions 12R, 12L are assembled to the rocker inner panels 104 and are therefore located at a lower elevation than the rear portion 11. In the attached figures, the front center portion 12C comprises an elevation transition on its right and left sides between a maximum elevation close to the elevation of the rear portion 11 and a minimum elevation. Other designs to manage the transition in elevation are also possible and constitute further embodiments of the current invention. For example, the elevation transition can be a general elevation transition spanning the full width of the part forming a general sloped portion at the back of the front portion 12.

The rear floor panel 1 according to the present invention is formed from a single metal blank. This has huge advantages in terms of simplifying the overall vehicle manufacturing, saving the complexity, time and cost of forming several parts separately and then assembling them together. It also ensures a better performance of the part in terms of crash resistance, fatigue and stiffness because there are no assembly points, for example made by spot welding which are generally weak points, liable to break under load or when submitted to repeated solicitations. Furthermore, if for example the single blank is formed by butt-to-butt welding of individual sub-blanks, there is no need for the overlap regions used in assembling several individual parts—limiting the number of overlap regions reduces the material use and saves CO2 emissions in manufacturing the material necessary to make the rear floor panel as well as reducing the overall weight of the rear floor panel, which in turns saves energy when using the vehicle.

The rear floor panel is involved in resisting intrusion and absorbing energy in the case of side impacts and in the case of rear impacts. When the vehicle is impacted from the rear, the crash energy exerted initially on the rear bumper is transmitted to rear crash boxes which are in longitudinal alignment with the side portions of the rear floor panel.

The left and right portions 11L, 11R, 12L, 12R are therefore reinforced compared to the center portions 11C, 12C, which does not have a major structural role in the case of impact. The product of ultimate tensile strength UTS, expressed in MPa, by the average thickness, expressed in mm, is generally considered a good indicator of the strength of a material. The higher it is, the stronger the material. In the case of the rear floor panel, the blank used to manufacture the part will have tailored material properties according to the corresponding portion of the rear floor panel in order to take into account the structural role of the side portions. Each of the rear left and right portions 11L, 11R comprise at least an area having a product of ultimate tensile strength UTS by average thickness which is at least twice as high, preferably three times as high, as the product of UTS by average thickness of the rear center portion 11C. Similarly, each of said front left and right portions 12L, 12R comprise at least an area having a product of UTS by average thickness which is at least twice as high, preferably three times as high, preferably four times as high, preferably five times as high, preferably six times as high, as the product of UTS by average thickness of the front center portion 12C.

Because the front portion 12 of the rear floor panel 1 is part of the passenger compartment 101, it plays a role in protecting the passengers from intrusion during a rear or side impact. On the other hand, the rear portion 11 is not part of the passenger compartment 101 and therefore can be deformed during a rear or side impact in order to absorb crash energy and prevent the crash energy from injuring the passengers. Taking into consideration these different roles of the front and rear portions, in a specific embodiment, the front left and right side portions 12L, 12R comprise at least an area having a product of UTS by average thickness which is for example at least 1.5 times higher, preferably at least 2 times higher, than the maximum product of UTS by average thickness of the rear left and right side portions 11L, 11R.

For example, the rear floor panel 1 is formed from a single blank by cold stamping. For example, the rear floor panel is formed from a single blank by hot stamping. For example, the rear floor panel is formed form a single blank by multistep hot stamping.

For example, the rear floor panel is formed from a single tailor welded blank by cold stamping or hot stamping. For example, the rear floor panel is formed from a single tailor welded blank in which the choice of thickness and material grade for each sub blank is such that after the stamping operation the above-described desired difference in UTS by thickness product is obtained on the final part. For example, the sub blanks are assembled by laser welding. For example, the rear floor panel is formed from a single tailor welded blank in which part of the sub blanks have been assembled together by butt-to-butt laser welding and part of the sub blanks have been assembled together by overlap welding. For example, said overlap welding operation is a resistance spot welding operation.

For example, the rear floor panel is formed from a single blank by partial hardening hot stamping in order to obtain said differentiated UTS by thickness products in the different areas of the final part.

Generally speaking, the difference in UTS by tensile strength of the side portions and the center portions leads to material transition zones. Referring to FIG. 3, these material transition zones are termed 12CR, 12CL, 11CR and 11CL, respectively to designate the transition between the front center and right portions, between the front center and left portions, between the rear center and right portions and between the rear center and left portions. These transition zones can be for example laser weld seams in the case of butt-to-butt laser welded blanks or overlap spot welded areas in the case of tailor welded blanks with overlap areas or gradual material property transition zones in the case of hot stamping with partial hardening. These transition zones can also be a combination of the previously listed possibilities, such as for example when performing a partial hardening hot stamping process on a laser welded blank. Other strategies are possible to tailor the final material properties, such as for example the use of tailored rolled blanks having a higher thickness on the sides than in the center—in this case the transition zones are thickness transition zones.

The inventors have found that the difference in strength and thickness between the side portions and the center portions coupled with the elevation difference within the rear floor panel represents a formability challenge to manufacture said part using a single metallic blank. The side parts will behave differently during deformation than the center parts and the difference in elevation means that a high amount of deformation needs to be applied to form the part. As a consequence, cracks due to forming are likely to occur in the above-mentioned transition zones 12CR, 12CL, 11CR and 11CL.

In a specific embodiment, the inventors have found that crack formation in the transition zones 12CR, 12CL, 11CR and 11CL was greatly limited and can be suppressed by placing said transition zones such that in the corresponding final formed part they are positioned in such a way that for any transverse cross section of the transition zone there is no difference in elevation on either side of said material transition zone. A transverse cross section of the part in a given area refers to a cross section along a plane perpendicular to the part in said area. In a specific embodiment, the inventors have found that cracks can be minimized and suppressed by ensuring that there is no difference in elevation throughout any transverse cross section over a width centered on the center of said transition zones 12CR, 12CL, 11CR and 11CL and spanning a width W equal to or greater than twice the thickness of the thicker material on either side of the transition zone. In a specific embodiment, the inventors have found that a value of W greater than or equal to 3 times the thickness of the thicker material, more preferably a value of W 4 times greater than or equal to the thickness of the thicker material is preferable to avoid cracks.

As previously described, in a specific embodiment, the front left and right side portions 12L, 12R comprise at least an area having a product of UTS by average thickness which is for example at least 1.5 times higher, preferably at least 2 times higher, than the maximum product of UTS by average thickness of the rear left and right side portions 11L, 11R. This in turn leads to transition zones 112R and 112L between the front and rear side portions as indicated on FIG. 3.

For the same reasons as described above, in a specific embodiment, there is no difference in elevation between the front and rear sides of said transition zones 112R and 112L for any transverse cross section of said transition zones. In a specific embodiment, the inventors have found that cracks can be minimized and suppressed by ensuring that there is no difference in elevation throughout any transverse cross section over an area centered on said transition zones 112R and 112L and spanning a width W equal to or greater than twice the thickness of the thicker material on either side of the transition zone. In a specific embodiment, the inventors have found that a value of W greater than or equal to 3 times the thickness of the thicker material, more preferably a value of W 4 times greater than or equal to the thickness of the thicker material is preferable to avoid cracks.

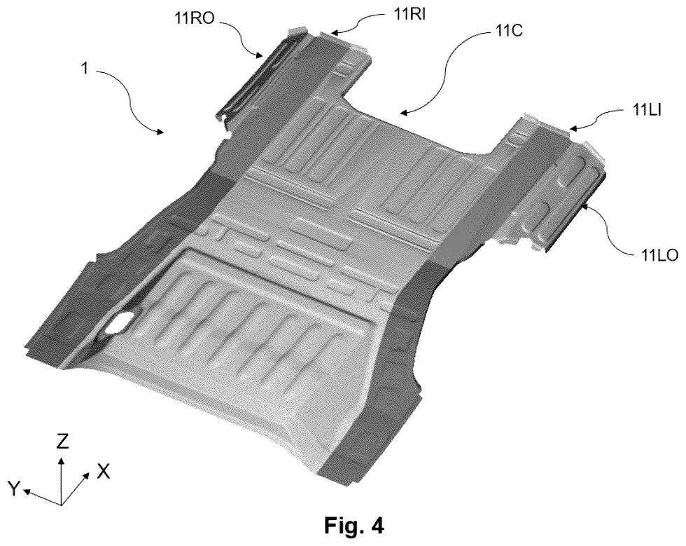

Referring to FIGS. 2 and 4, in a specific embodiment, the rear left and right portions 11L, 11R comprise an inner portion 11LI, 11RI, and an outer portion 11LO, 11RO, and the product of the UTS by average thickness of each of said inner portions 11LI, 11RI is at least twice as high as the product of UTS by average thickness of each of said rear outer portion 11LO, 11RO. Advantageously, this allows to further integrate in a single part, made from a single metallic blank, the outer areas of the body in white closing the rear floor panel on its rear outer sides. The rear left and right outer portions 11LO, 11RO, do not play a major structural role in the vehicle and have relatively complex shapes. It is therefore interesting to have lower thickness and grades for these parts to allow them to be formed into more complex shapes and not make unnecessary use of high strength materials in areas where it is not necessary. For example, the product of the UTS by average thickness of each of said inner portions 11LI, 11RI is at least twice as high as the product of UTS by average thickness of each of said rear outer portions 11LO, 11RO.

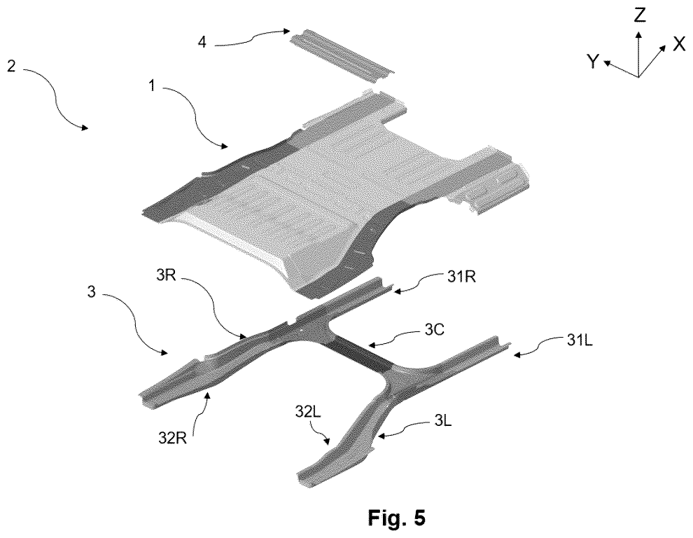

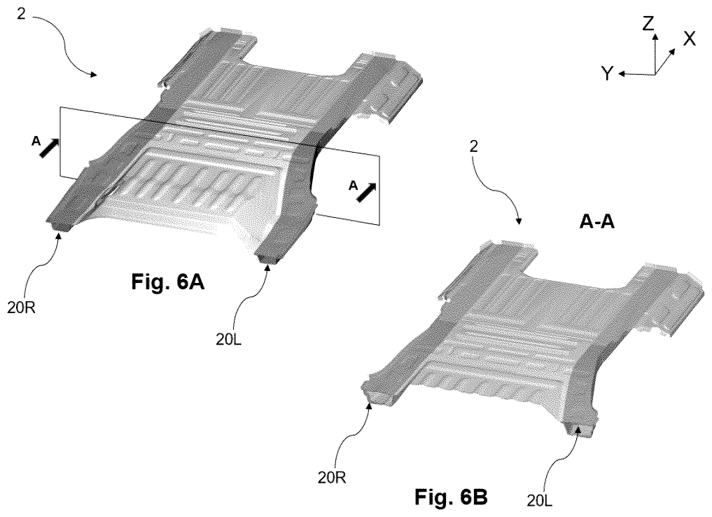

Referring to FIGS. 5, 6A and 6B, a further object of the present invention is a rear structural assembly 2 for an automotive vehicle comprising at least a rear floor panel 1 as previously described and a rear underfloor structure 3 comprising itself a left and right side member 3L, 3R and at least one cross member 3C linking said right and left side members 3L, 3R. When said rear structural assembly 2 is assembled in the vehicle:

The left rear and front portions 11L, 12L of said rear floor panel 1 form together with said rear underfloor structure left side member 3L a closed section encompassing a left hollow volume 20L.

The right rear and front portions 11R, 12R of said rear floor panel 1 form together with said rear underfloor structure right member 3R a closed section encompassing a right hollow volume 20R.

The center rear and front portions 11C, 12C of said rear floor panel 1 form together with said rear underfloor structure's at least one cross member 3C a closed section encompassing a center hollow volume 20C.

Advantageously, by combining said rear floor panel 1 and rear underfloor structure 3 into a rear structural assembly 2 having hollow volumes 20L, 20R, 20C with reinforced high strength materials making up at least part of the walls encompassing said hollow volumes, it is possible to produce an extremely rigid and crash resistant structure capable of absorbing crash energy and resisting intrusion in the case of a crash and also conferring an excellent rigidity to the rear part of the vehicle body in white.

In a specific embodiment, and for the same reasons as described above regarding the difference in the product of UTS by thickness between the front and rear side portions of the rear floor panel, the left and right members 3L, 3R of the rear underfloor assembly 3 each comprise a rear portion 31L, 31R and a front portion 32L, 32R substantially corresponding respectively to the location in the assembled vehicle of the rear and front portions 11 and 12 of the rear floor panel 1. For example, the product of UTS by average thickness of the front portions 32L, 32R is at least 1.15 times, preferably 1.20 times, preferably 1.25 times, that of the rear portions 31L, 31R.

In a specific embodiment, said rear underfloor structure 3 is made by forming a single metal blank, for example by hot stamping a single metal blank. Advantageously, this allows to provide a full rear structural assembly 2 by assembling only two parts, each made from a single metal blank. This affords huge advantages in terms of productivity, logistics, costs, crash worthiness, reduction of spot welding and overall reduction of CO₂ emissions in the manufacturing process.

In a further embodiment, the rear structural assembly 2 further comprises at least one top cross member 4 assembled on top of the rear floor panel 1 and extending longitudinally between the left and right portions of said rear floor panel 1 and located at an elevation above the at least one cross member 3C of the rear underfloor structure 3. Advantageously, this allows to further reinforce the area corresponding to the crash resistant and rigid center hollow volume 20C.

In a specific embodiment the rear floor panel 1 and/or the rear underfloor structure 3 according to the invention is made by cold forming steel sheets and the blanks used to produce them comprise at least one of the following materials, either in the form of monolithic blanks, tailor rolled blanks or combined in the form of tailor welded blanks:

Steel having a chemical composition comprising in weight %: 0.13%<C<0.25%, 2.0%<Mn<3.0%, 1.2%<Si<2.5%, 0.02%<Al<1.0%, with 1.22%<Si+Al<2.5%, Nb<0.05%, Cr<0.5%, Mo<0.5%, Ti<0.05%, the remainder being Fe and unavoidable impurities and having a microstructure comprising between 8% and 15% of retained austenite, the remainder being ferrite, martensite and bainite, wherein the sum of martensite and bainite fractions is comprised between 70% and 92%. With this composition, the steel sheet has, as measured in the rolling direction, a yield strength comprised between 600 MPa and 750 MPa and an ultimate tensile strength comprised between 980 MPa and 1300 MPa while keeping a total elongation above 19%. For example, this material is used at least for part of the areas corresponding to the side portions 11L, 11R, 12L, 12R of the rear floor panel 1.

Steel having a chemical composition comprising in weight %: %: 0.15%<C<0.25%, 1.4%<Mn<2.6%, 0.6%<Si<1.5%, 0.02%<Al<1.0%, with 1.0%<Si+Al<2.4%, Nb<0.05%, Cr<0.5%, Mo<0.5%, the remainder being Fe and unavoidable impurities and having a microstructure comprising between 10% and 20% of retained austenite, the remainder being ferrite, martensite and bainite. With this composition, the steel sheet has, as measured in the rolling direction, a yield strength comprised between 850 MPa and 1060 MPa and an ultimate tensile strength comprised between 1180 MPa and 1330 MPa while keeping a total elongation above 13%. For example, this material is used at least for part of the areas corresponding to the side portions 11L, 11R, 12L, 12R of the rear floor panel 1.

Fully martensitic steel wherein the composition of the fully martensitic steel comprises in % weight: 0.15%≤C≤0.5%. For example, this material is used at least for part of the areas corresponding to the side portions 11L, 11R, 12L, 12R of the rear floor panel 1.

Dual phase steel having a microstructure comprising at least martensite and ferrite and having a UTS of at least 590 MPa. For example, this material is used at least for part of the areas corresponding to the side portions 11L, 11R, 12L, 12R of the rear floor panel 1.

Dual phase steel having a microstructure comprising at least martensite and ferrite and having a UTS of at least 780 MPa. For example, this material is used at least for part of the areas corresponding to the side portions 11L, 11R, 12L, 12R of the rear floor panel 1.

Dual phase steel having a microstructure comprising at least martensite and ferrite and having a UTS of at least 980 MPa. For example, this material is used at least for part of the areas corresponding to the side portions 11L, 11R, 12L, 12R of the rear floor panel 1.

In a specific embodiment the rear floor panel 1 and/or the rear underfloor structure 3 according to the invention is made by hot stamping steel sheets and the blanks used to produce them comprise at least one of the following materials, either in the form of monolithic blanks, tailor rolled blanks or combined in the form of tailor welded blanks:

Steel having a composition comprising in % weight: 0.06%≤C≤0.1%, 1%≤Mn≤2%, Si≤0.5%, Al≤0.1%, 0.02%≤Cr≤0.1%, 0.02%≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the elaboration. With this composition range, the yield strength of the corresponding area after hot stamping is comprised between 700 and 950 MPa, the tensile strength between 950 MPa and 1200 MPa and the bending angle is above 75°. For example, this material is used in the area corresponding to the rear portions 11L, 11R, 31L or 31R, because it absorbs energy by deforming without cracking.

Steel having an ultimate tensile strength after hot stamping which is comprised between 1300 MPa and 1650 MPa and a yield strength which is comprised between 950 MPa and 1250 MPa.

Steel having an ultimate tensile strength after hot stamping which is comprised between 1300 MPa and 1650 MPa, a yield strength which is comprised between 950 MPa and 1250 MPa and a bending angle which is above 75°.

Steel having a composition comprising in % weight: 0.20%≤C≤0.25%, 1.1%≤Mn≤1.4%, 0.15%≤Si≤0.35%, Cr≤0.30%, 0.020%≤Ti≤0.060%, 0.020%≤Al≤0.060%, S≤0.005%, P≤0.025%, 0.002%≤B≤0.004%, the remainder being iron and unavoidable impurities resulting from the elaboration. With this composition range, the ultimate tensile strength of the corresponding area of the part after hot stamping is comprised between 1300 MPa and 1650 MPa and the yield strength is comprised between 950 MPa and 1250 MPa. For example, this steel composition is used for the areas corresponding to the front portions 12L, 12R, 32L or 32R. Indeed, this steel grade has high anti-intrusion properties.

Steel having a tensile strength after press-hardening higher than 1800 MPa.

Steel having a composition which comprises in % weight: 0.24%≤C≤0.38%, 0.40%≤Mn≤3%, 0.10%≤Si≤0.70%, 0.015%≤Al≤0.070%, Cr≤2%, 0.25%≤Ni≤2%, 0.015%≤Ti≤0.10%, Nb≤0.060%, 0.0005%≤B≤0.0040%, 0.003%≤N≤0.010%, S≤0,005%, P≤0,025%, %, the remainder being iron and unavoidable impurities resulting from the elaboration. With this composition range, the tensile strength of the corresponding area after hot stamping is higher than 1800 MPa. For example, this material is used in the front portions 12L, 12R, 32L or 32R, to benefit from its high anti-intrusion properties.

Steel having a composition which comprises in % weight: C: 0.15-0.25%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Mo≤0.40%, Nb≤0.08%, Ca≤0.1%, the remainder of the composition being iron and unavoidable impurities resulting from the smelting. With this composition range, the tensile strength of the corresponding area of the dash panel assembly after hot stamping is higher than 1350 MPa and the bending angle is higher than 70°.

Steel having a composition which comprises in % weight: C: 0.26-0.40%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Ni≤0.5%, Mo≤0.40%, Nb≤0.08%, Ca≤0.1% the remainder of the composition being iron and unavoidable impurities resulting from the smelting. With this composition range, the tensile strength of the corresponding area after hot stamping is higher than 1350 MPa and the bending angle is higher than 70°.

Steel having a composition which comprises in % weight: C: 0.2-0.34%, Mn: 0.50-1.24%, Si: 0.5-2%, P≤0.020%, S≤0.010%, N≤0.010%, and comprising optionally one or more of the following elements, by weight percent: Al: ≤0.2%, Cr≤0.8%, Nb≤0.06%, Ti≤0.06%, B≤0.005%, Mo≤0.35%, the remainder of the composition being iron and unavoidable impurities resulting from the smelting. With this composition range, the tensile strength of the corresponding after hot stamping is equal to or higher than 1000 MPa and the bending angle is higher than 55°.

Steel having a composition which comprises in % weight: C: 0.13-0.4%, Mn: 0.4-4.2%, Si: 0.1-2.5%, Cr≤2%, Mo≤0.65%, Nb≤0.1%, Al≤3.0%, Ti≤0.1%, B≤0.005%, P≤0.025%, S≤0.01%, N≤0.01%, Ni≤2.0%, Ca≤0.1%, W≤0.30%, V≤0.1%, Cu≤0.2%, and verifying the following combination: 114-68*C−18*Mn+20*Si-56*Cr-60*Ni-36*Al+38*Mo+79*Nb-17691*B<20, the remainder of the composition being iron and unavoidable impurities resulting from the smelting. For example, this composition is used when hot stamping the part using a multistep process.

Steel which is coated with an aluminum-based metallic coating. By aluminum based it is meant a coating that comprises at least 50% of aluminum in weight. For example, the metallic coating is an aluminum-based coating comprising 8-12% in weight of Si. For example, the metallic coating is applied by dipping the base material in a molten metallic bath. Advantageously, applying an aluminum-based metallic coating avoids the formation of surface scale during the heating step of the hot stamping process, which in turn allows to produce the parts by hot stamping without a subsequent sand blasting operation. Furthermore, the aluminum-based coating also provides corrosion protection to the part while in service on the vehicle.

Steel which is coated with an aluminum-based metallic coating comprising from 2.0 to 24.0% by weight of zinc, from 1.1 to 12.0% by weight of silicon, optionally from 0 to 8.0% by weight of magnesium, and optionally additional elements chosen from Pb, Ni, Zr, or Hf, the content by weight of each additional element being inferior to 0.3% by weight, the balance being aluminum and optionally unavoidable impurities. Advantageously, this type of metallic coating affords very good corrosion protection on the part, as well as a good surface aspect after hot stamping.

In a specific embodiment, the rear floor panel 1 and/or the rear underfloor structure 3 is made by hot stamping a laser welded blank comprising at least one sub blank having an aluminum based metallic coating and said aluminum coated sub-blanks are prepared before-hand by ablating at least part of the metallic coating on the edges to be welded. Advantageously, this removes part of the aluminum present in the coating, which would pollute the weld seam and deteriorate its mechanical properties.

In a particular embodiment, the rear floor panel 1 and/or the rear underfloor structure 3 is made by hot stamping a laser welded blank comprising at least one sub blank having at least one side topped with an emissivity increasing top layer. Said emissivity increasing top layer is applied on the outermost surface of said sub-blank. Said emissivity increasing top layer allows the surface of said sub blank to have a higher emissivity compared to the same sub-blank which is not coated with said emissivity increasing top layer. Said emissivity increasing top layer can be applied either on the top or the bottom side of a sub-blank. Said emissivity increasing top layer can also be applied on both sides of said sub-blank. If said sub-blank comprises a metallic coating, such as described previously, the emissivity increasing top layer is applied on top of said metallic coating. Indeed, for the emissivity increasing top layer to increase the emissivity of the surface, it needs to cover the outermost surface of the sub-blank. Advantageously, said emissivity increasing top layer will allow to increase the heating rate of said sub-blank and therefore increase the productivity of the heating step of the hot stamping process. When using several sub blanks of differing thicknesses, said emissivity increasing top layer is advantageously applied to the sub-blanks having the highest thickness in order to decrease the difference in heating time between the different sub-blanks and therefore increase productivity, increase the hot stamping process window and overall allow to obtain a final part having homogeneous surface properties.

1-9. (canceled)

10. A rear floor panel for a motor vehicle extending longitudinally from a rear extremity of the vehicle to a front extremity of back passenger seats and extending transversally between a left and right wheelhouse and a left and right rocker inner, the rear floor panel comprising:
a front portion extending below the back passenger seats and a rear portion extending behind the back passenger seats, the front and rear portions each respectively comprising a left, center and right portion, wherein
the rear floor panel is made by forming a single metal sheet,
the right and left front portions are assembled to the right and left rocker inner and are located at a lower elevation than the rear portion,
each of the rear left and right portions comprise at least an area having a product of ultimate tensile strength UTS expressed in MPa, by average thickness, expressed in mm, at least twice as high as a rear center portion product of UTS by average thickness of the rear center portion,
each of the front left and right portions comprise at least an area having a product of ultimate tensile strength UTS by average thickness at least twice as high as a front center portion product of UTS by average thickness of the front center portion.

11. The rear floor panel according to claim 10 include material transition zones respectively between the front center and right portions, between the front center and left portions, between the rear center and right portions and between the rear center and left portions, wherein for any given transverse cross section there is no difference in elevation on either side of the material transition zones over a width centered on the center of the material transition zone and spanning at least twice the thickness of the thicker material on either side of the material transition zone.

12. The rear floor panel according to claim 11 wherein the single metal sheet is a tailor welded blank including sub-blanks welded butt-to-butt with welds, the welds being laser welds.

13. The rear floor panel according to claim 10 wherein the rear left and right portions include an inner portion and an outer portion, and wherein the product of the UTS by average thickness of each of the inner portions is at least twice as high as a rear outer portion product of UTS by average thickness of each of the rear outer portions.

14. The rear floor panel according to claim 10 wherein the area of each of the rear left and right portions has the product of UTS by average thickness at least three times as high as the rear center portion product.

15. The rear floor panel according to claim 10 wherein the area of each of the front left and right portions has the product of UTS by average thickness at least four times as high as the front center portion product.

16. A rear structural assembly for an automotive vehicle comprising at least a rear floor panel as recited in claim 10 and a rear underfloor structure, the rear underfloor structure comprising a left and right side member and at least one cross member linking the right and left side members, wherein when the rear structural assembly is assembled in the vehicle:
the left rear and front portions of the rear floor panel form together with the rear underfloor structure left member a closed section encompassing a left hollow volume, the right rear and front portions of the rear floor panel form together with the rear underfloor structure right member a closed section encompassing a right hollow volume, the center rear and front portions of the rear floor panel form together with the at least one cross member of the rear underfloor structure a closed section encompassing a center hollow volume.

17. The rear structural assembly according to claim 16 wherein the rear underfloor structure is made by forming a single metal blank.

18. The rear structural assembly according to claim 16 including at least one top cross member assembled on top of the rear floor panel and extending longitudinally between the left and right portions of the rear floor panel and located at an elevation above the at least one cross member of the rear underfloor structure.
